(19) United States
(12) Patent Application Publication
(10) Pub. No.: US 2006/0211424 A1
(43) Pub. Date: Sep. 21, 2006

(54) METHOD FOR ESTABLISHING A COLLECT CALL THROUGH A WIRELESS COMMUNICATION SYSTEM

(76) Inventor: Sheng-Hsien Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/308,335

(22) Filed: Mar. 16, 2006

(30) Foreign Application Priority Data
Mar. 18, 2005 (TW) 094108380

(51) Int. Cl. H04Q 7/20

(52) U.S. Cl. 455/445

(57) ABSTRACT

A method includes a first mobile phone sending a first request to a communication service provider system, the communication service provider system sending a second request to a second mobile phone based on the first request and the phone number of the first mobile phone, and the second mobile phone making a call to the first mobile phone after accepting the second request.

### BACKGROUND OF THE INVENTION

1. Field of the Invention

The present invention relates to a method for establishing a collect call through a wireless communication system, and more particularly, to a method of a mobile phone of a person being called establishing communication with a mobile phone of a caller.

2. Description of the Prior Art

In modern society, wireless communication is available for everyone. People can wirelessly communicate with each other anytime and anywhere via mobile phone with the advantage of convenience, light weight, and easy operation.

Generally speaking, there are two ways to pay for wireless communication. One is to pay in advance, and the other is to pay by monthly installments. The former requires that the user purchase an advance card. A fee is deducted directly from the balance of the advance card when making a call, until the balance reaches zero. The user then has to add money to the advance card. If not, the advance card does not allow the user to make any phone calls. The latter method is that the user applies for an account from a communication service provider system, and receives a bill for the previous month of mobile phone use.

No matter which way the user selects, the communication service provider system only charges the user who makes calls or establishes communication. Suppose that the user pays the communication fee by the advance card. If there is an emergency and the user has to contact others with his mobile phone, but there is no money on the advance card, the user cannot reach anyone by phone. Or suppose that the user pays the bill monthly, but wants to economize on the expense of wireless communication. The caller would dial a call, and ask the person being called to call back. In wireless communication systems of the prior art, there is no way to allow the caller to ask the person being called to pay the fee before communication is established. In the prior art, the communication service provider system cannot provide these more flexible functions to users.

### SUMMARY OF THE INVENTION

It is therefore a primary objective of the claimed invention to provide a method for establishing a collect call through a wireless communication system in order to solve the above-mentioned problems.

The claimed invention provides a method for establishing a collect call through a wireless communication system. The system comprises a first mobile phone and a second mobile phone. The method comprises the first mobile phone sending a first request to a communication service provider system, the communication service provider system sending a second request to the second mobile phone based on the first request and the phone number of the first mobile phone, and if the second mobile phone accepts the second request, the second mobile phone making a call to the first mobile phone.

The claimed invention further provides a method for establishing a collect call through a wireless communication system. The system comprises a first mobile phone and a second mobile phone. The method comprises the first mobile phone sending a first request including a first specific code and the phone number of the second mobile phone to a communication service provider system, and the communication service provider system sending a second request including a second specific code and the phone number of the first mobile phone to the second mobile phone based on the first request and the phone number of the first mobile phone. If the second mobile phone refuses the second request, the second request is ended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of establishing a collect call through a wireless communication system based on the present invention.

FIG. 2 is a flowchart of establishing a collect call according to the present invention.

### DETAILED DESCRIPTION

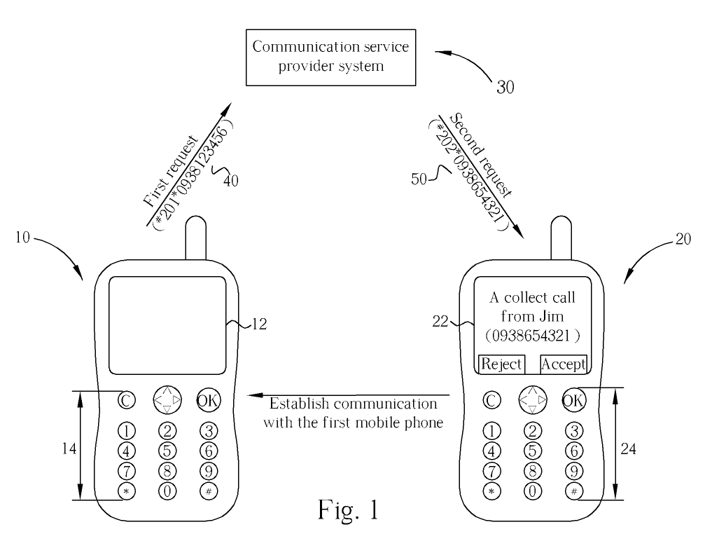

Please refer to FIG. 1, which is a diagram of establishing a collect call through a wireless communication system based on the present invention. The user of a first mobile phone 10 sends a first request 40 to a communication service provider system 30. The communication service provider system 30 immediately parses the information in first request 40, and sends a second request 50 to the second mobile phone 20 based on the first request 40 and the phone number of the first mobile phone 10. In other words, the first request 40 comprises a first specific code and the phone number of the second mobile phone 20, so that the communication service provider system 30 can acquire the phone number that the first mobile phone 10 wants to communicate with, and execute the second request 50 based on the first specific code. The second request 50 comprises a second specific code and the phone number of the caller (the first mobile phone 10). The second mobile phone 20 uses the second specific code of the second request 50 to execute an action accordingly, and knows who sends the request by the phone number included in the second request 50. As shown in FIG. 1, for example, the information of the first request 40 is “#201*0938123456”, wherein “201” is the first specific code and “0938123456” is the phone number of the second mobile phone 20. The first request 40 indicates to send a message with the second specific code to the second mobile phone 20. The information of the second request 50 is “#202*0938654321”, wherein “202” is the second specific code and “0938654321” is the phone number of the caller (the first mobile phone 10). The second request 50 indicates to make a formal call to the first mobile phone 10. The details are described later.

When the second mobile phone 20 receives the second request 50 of the communication service provider system 30, the display 22 of the second mobile phone 20 shows an option to accept or reject the second request 50 with the name or phone number of the the first mobile phone 10. The user of the second mobile phone 20 can accept or refuse the second request 50 by pushing a button 24 or any other input device that can input the commands of acceptance or rejection. In addition to accepting or refusing the request manually, the mobile phone can be set to automatically accept or refuse the collect call.

If the user of the second mobile phone 20 accepts the collect call, the second mobile phone 20 automatically dials the phone number of the first mobile phone 10 based on the second request 50 to establish communication with the first mobile phone 10. Communication between the first mobile phone 10 and the second mobile phone 20 is not established until the second mobile phone 20 accepts the collect call (i.e. the second request 50), and automatically establishes communication. Since the second mobile phone 20 establishes the communication, the communication service provider system 30 only charges the user of the second mobile phone 20. The user of the first mobile phone 10 does not have to pay any fee. In this way, if there is no money on the advance card, or the user wants to save money, the present invention can provide a convenient way to ask the person being called for a collect call.

Additionally, the first mobile phone 10 starts a timer after sending the first request 40 to avoid waiting for a long time. If the waiting time exceeds a predetermined period, the first mobile phone 10 can execute a proper response.

For instance, after sending the first request 40, the first mobile phone 10 starts its timer to detect whether the waiting time exceeds the predetermined period to avoid keeping the user of the first mobile phone 10 waiting for a long time. If the waiting time exceeds the predetermined period, the first mobile phone 10 automatically informs the user that there is no response from the person being called or that time is up by displaying a related message on the display 12 or a voice message.

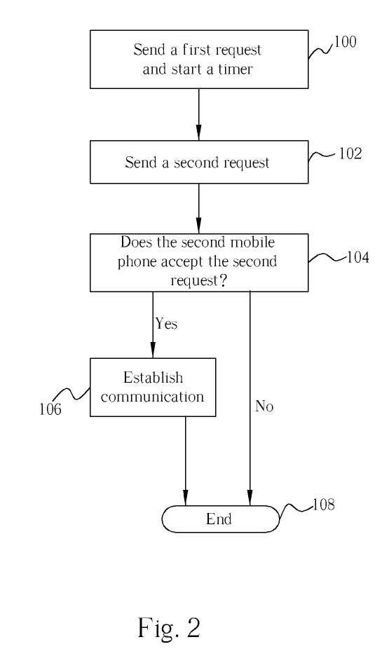

Please refer to FIG. 2, which is a flowchart of establishing a collect call according to the present invention. The steps are as follows.

Step 100: The first mobile phone 10 sends a first request 40 to the communication service provider system 30. The information of the first request 40 includes “#201*0938123456”, wherein “201” is the first specific code, and “0938123456” is the phone number of the second mobile phone 20. If the first mobile phone 10 has a timer, the timer is started to detect whether the waiting time exceeds the predetermined period after sending the first request 40.

Step 1102: The communication service provider system 30 sends the second request 50 to the second mobile phone 20. The information of the second request 50 includes “#202*0938654321”, wherein “202” is generated based on the first specific code “201” of the first request 40, and “0938654321” is the phone number of the caller (the first mobile phone 10).

Step 104: After the second mobile phone 20 receives the second request 50, the display 22 of the second mobile phone 20 displays the name or number of the caller, an accept option, and a reject option. If accepting the request, step 106 is entered. Otherwise, step 108 is entered.

Step 106: The second mobile phone 20 automatically establishes communication with the first mobile phone 10 based on the information of the second request 50. After the communication between the first mobile phone 10 and the second mobile phone 20 is established, the timer of the first mobile phone 10 is disabled.

Step 108: The communication ends.

Since communication service provider systems have unstructured supplementary service data (USSD), as long as communication service provider systems establish the request form of the present invention, such as “#201*phone number” and “#202*phone number”, the present invention can be implemented in all wireless communication systems. The request form of the present invention is not limited as the above.

Compared to the prior art, the present invention provides a service to the user of the mobile phone to ask the person being called for a collect call before communication is established. The caller only sends a specific request to a communication service provider system. No connector is needed to pass the collect call to the person being called. If the person being called accepts the request, the mobile phone of the person being called can automatically establish the communication. Instead of the person being called dialing the number manually, the mobile phone automatically makes the call to the caller. In addition, the communication service provider system only charges the person who establishes communication. Thus, the present invention provides a flexible method for the user when there is no money on the advance card or the user wants to economize on his expenses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for establishing a collect call through a wireless communication system, the system comprising a first mobile phone and a second mobile phone, the method comprising:
(a) the first mobile phone sending a first request to a communication service provider system;
(b) the communication service provider system sending a second request to the second mobile phone based on the first request and the phone number of the first mobile phone; and
(c) when the second mobile phone accepts the second request, the second mobile phone making a call to the first mobile phone.

2. The method of claim 1 wherein the first request comprises a first specific code and the phone number of the second mobile phone, and step (b) comprises the communication service provider system parsing the first request to acquire the first specific code and the phone number of the second mobile phone.

3. The method of claim 1 wherein step (b) comprises the communication service provider system integrating a second specific code and the phone number of the first mobile phone to generate the second request.

4. The method of claim 1 wherein step (c) comprises the second mobile phone parsing the second request for acquiring the phone number of the first mobile phone.

5. The method of claim 1 further comprising displaying the phone number or name of the first mobile phone, an accept option, and a reject option on a display of the second mobile phone.

6. The method of claim 1 wherein accepting the second request of step (c) comprises the second mobile phone receiving a command from an input device on the second mobile phone, the command corresponding to the accept option for establishing communication with the first mobile phone.

7. The method of claim 1 further comprising starting a timer after sending the first request.

8. A method for establishing a collect call through a wireless communication system, the system comprising a first mobile phone and a second mobile phone, the method comprising:
(a) the first mobile phone sending a first request including a first specific code and the phone number of the second mobile phone to a communication service provider system;
(b) the communication service provider system sending a second request including a second specific code and the phone number of the first mobile phone to the second mobile phone based on the first request and the phone number of the first mobile phone; and
(c) when the second mobile phone refuses the second request, the second request is ended.

9. The method of claim 8 further comprising displaying the phone number or name of the first mobile phone, an accept option, and a reject option on a display of the second mobile phone.

10. The method of claim 8 wherein refusing the second request of step (c) comprises the second mobile phone receiving a command from an input device on the second mobile phone, the command corresponding to the reject option for ending the second request.

11. The method of claim 8 further comprising starting a timer after sending the first request.
